(19) United States
(12) Patent Application Publication
(10) Pub. No.: US 2022/0152432 A1
(43) Pub. Date: May 19, 2022

(54) FACE MASK

(71) Applicant: Larry Ray Kane, North Ridgeville, OH (US)

(72) Inventor: Larry Ray Kane, North Ridgeville, OH (US)

(21) Appl. No.: 17/483,261

(22) Filed: Sep. 23, 2021

Related U.S. Application Data
(60) Provisional application No. 63/082,366, filed on Sep. 23, 2020.

(51) Int. Cl. A62B 18/08; A41D 13/11; A62B 23/02; H04R 3/04; H04R 1/08; H04R 1/02

(52) U.S. Cl. CPC A62B 18/08; A41D 13/11; H04R 1/028; H04R 3/04; H04R 1/08; A62B 23/02

(57) ABSTRACT

An improved face mask includes a plastic face shield that is formed from a material with sufficient flexibility to confirm to the face of the user. The face mask has a first, distal, open end configured to cover the mouth and nose of the associated user, and a second, proximal end having an enlarged opening therethrough. A cage is secured to and extends outwardly from the proximal end of the face shield. A filter is mounted to the face mask via the cage. An amplifier and microphone is secured to the cage.

### BACKGROUND

This application claims the priority benefit of U.S. provisional application Ser. No. 63/082,366, filed Sep. 23, 2020, the entire disclosure of which is expressly incorporated herein by reference.

This invention relates to face masks. Current face masks restrict the view of a face of a wearer/user which makes in person communication difficult. Furthermore, the current face masks also muffle a voice of the user making communication difficult.

A need exists for an improved arrangement that provides visibility of a mouth of the user and the ability to amplify the speech of the user.

### SUMMARY

An improved face mask is disclosed herein. The improved face mask includes a plastic face shield that is formed from a material with sufficient flexibility to confirm to the face of the user. The face mask has a first, distal, open end configured to cover the mouth and nose of the associated user, and a second, proximal end having an enlarged opening therethrough. A cage is secured to and extends outwardly from the proximal end of the face shield. A filter is mounted to the face mask via the cage.

An amplifier and microphone is secured to the cage.

In a first embodiment, the filter is made of a material that has a filtration efficiency greater than 95 percent (i.e., a so-called N95 filter that has been found particularly desirable in connection with filtering and potentially limiting the spread of the COVID-19 virus that is believed to be spread via respiratory droplets).

Many different filter materials may address this goal, and one preferred material is polypropylene fiber.

Another feature of the present invention is the ability to insert a lens into the outer terminal of the end cage. The lens allows other individuals to read the lips and see the facial expressions of the face mask user during communication. The lens would be preferably but not limited to being formed from a material that exhibits suitable anti-fogging capabilities such as polycarbonate.

The amplifier and microphone may be controlled by a common circuit. The microphone and amplifier preferably include a dual operation amplifier that receives input from the microphone. The circuit then filters that input and outputs a signal to first and second low voltage audio amplifiers which then output positive and negative speaker signals, respectively.

A retainer may include a knockout hole in the plastic face shield that will accommodate and contain the optional microphone and amplifier assembly.

One advantage of this disclosure relates to the ease of understanding what a user who is wearing the face mask has said.

Another advantage relates to the ease of seeing and interpreting the facial expressions of the user wearing the face mask.

Another benefit resides in the ability to provide filtered air to the face mask user, while simultaneously allowing those in communication with the user to view the mouth of the user, and optionally incorporate the amplifier and microphone assembly to increase the volume of the speech of the face mask user.

A further advantage of this disclosure relates to the ability to easily add and/or remove the microphone and amplifier assembly based on needs of the individual user.

Still other benefits and advantages of the present disclosure will become more apparent from reading and understanding the following detailed description.

### BRIEF DESCRIPTION OF THE DRAWINGS

FIG. 1 is an elevational or side view of the present invention.

FIG. 2 is an exploded side view of the embodiment of FIG. 1 a face mask that includes a microphone and amplifier assembly.

FIG. 3 is an exploded side view of a second embodiment of a mask that does not include a microphone or amplifier.

FIGS. 4A and 4B are front and side views of a snap fit ring that retains the filter of the face mask and also contains a microphone and amplifier assembly.

FIG. 5 is a schematic diagram of a microphone and amplifier circuit.

FIG. 6 is a perspective view of the face mask with support strap tabs and support straps shown assembled thereto.

FIG. 7 is a top view of the face mask shown in FIG. 6.

FIG. 8 is an elevational view of the face mask of FIG. 6.

FIG. 9 it is a front view of the face mask of FIG. 6.

FIG. 10 it is a cross-sectional view taken generally along the lines 10-10 of FIG. 9.

FIG. 11 is an enlarged sectional view of the encircled portion of FIG. 10.

FIG. 12 is a perspective view of the face mask with an audio amplifier taken generally from the front and a first side.

FIG. 13 is a perspective view of the face mask with the audio amplifier of FIG. 12 taken generally from the front and a second side.

FIG. 14 is a front view of the face mask of FIG. 12 worn by a user.

FIG. 15 is a side view of the face mask of FIG. 12 worn by a user.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Similar components in different embodiments will be given the same number for clarification purposes, and for purposes of brevity.

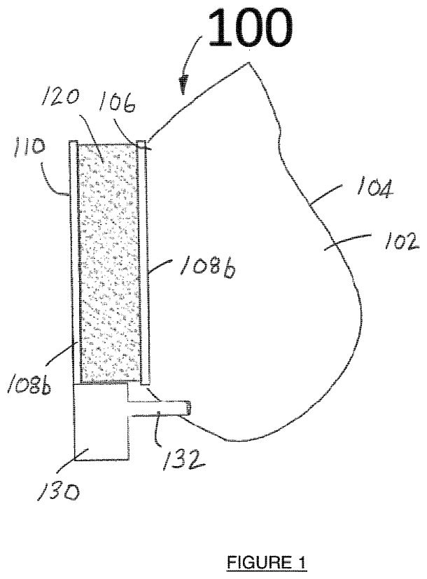

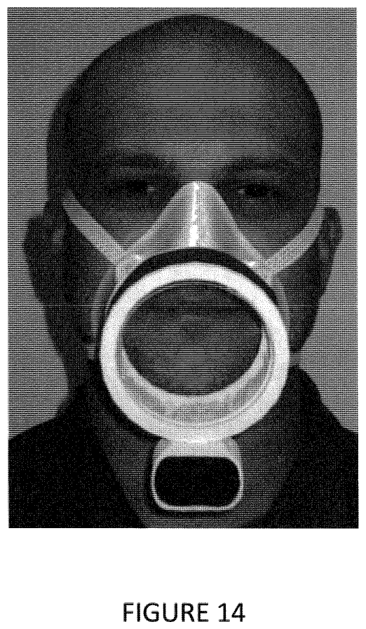

FIG. 1 illustrates an assembled or complete face mask 100. A flexible, translucent face portion 102 is contoured for receipt over the nose and around the mouth and chin of an associated user (not shown). The flexible material that forms the face portion is sufficiently pliable to conform to the contours of the face of the user. A first, distal, open end 104 is configured to cover the mouth, nose, and chin of the user and is axially spaced from a second, proximal end 106 of the face mask 100. Preferably, the face mask 100 has a generally annular configuration so that the second end 106 includes a central opening 109 that allows other people communicating with the face mask wearer to see through a clear lens 110 and view around the mouth of the face mask user (FIG. 14).

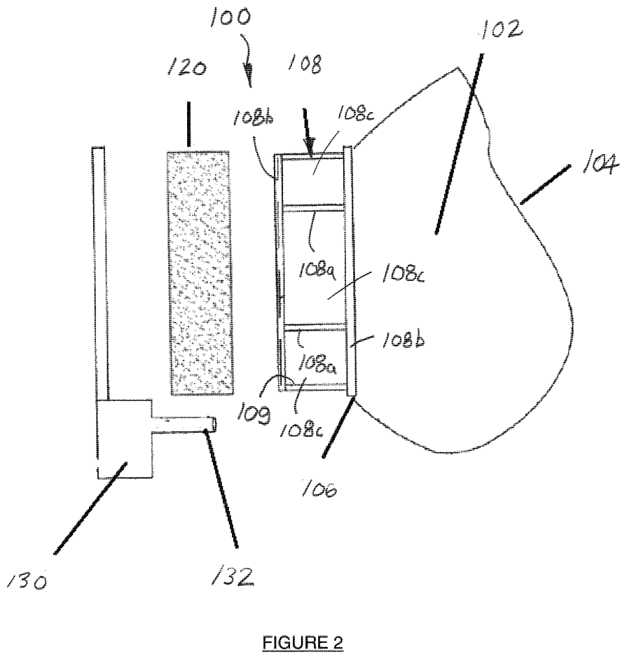

As more particularly shown in FIG. 2, the face mask 100 includes a cage 108 that extends outwardly from the second, proximal end 106 of the face shield 102. An annular filter 120 is received in or on the cage 108. Because the cage 108 has an annular configuration with axially extending supports 108a interconnecting circular support members 108b disposed in axially spaced relation, large circumferentially spaced openings 108c are formed between the supports 108a, 108b and allow air flow in a radial direction therethrough. Filter 120 is received on the cage 108, and dimensioned to cover the openings 108c so that airflow inhaled or exhaled by the face mask user must pass through the filter 120. That is, the face portion 102 is urged by straps (to be described below) into sealing engagement with the face of the user and the clear lens 110 closes the opening 109, so that airflow to and from the user wearing the face mask 100 passes through the filter 120 and radial openings 108c in the cage 108. This is true of the embodiments of FIGS. 1-2 and FIG. 3.

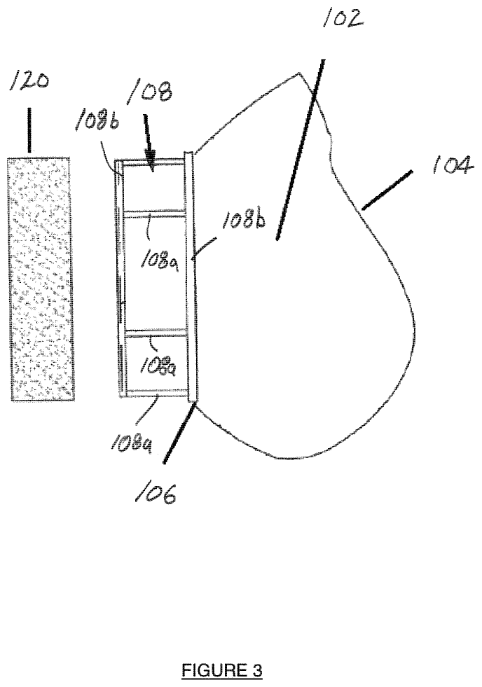

Also illustrated in FIGS. 1 and 2 are the inclusion of an amplifier/microphone assembly 130. More particularly, the amplifier and speaker/microphone assembly 130 includes amplifier/speaker 130 and microphone 132 that are secured to the cage 108. The amplifier/speaker 130 provides an external, forwardly directed speaker on the face mask 100 so that listeners can hear the amplified speech picked up by the microphone 132 (that extends through a sealed opening in the face portion 102). Thus, the speaker 130, as well as the ability to view the mouth portion of the face of the user through the clear lens 110 (FIG. 14), enhances the ability to understand the user. It is also evident from FIG. 3 that a version of the face mask 100 may not include the speaker and microphone assembly, and only provide for the ability to view the mouth of the user through the lens 110 received on the open end of the cage 108 secured to the second and 106 of the face portion 102. Preferably, the amplifier/speaker/microphone assembly is battery operated, and the battery(ies) can be conveniently recharged by a power cord (e.g., USB or the like)(not shown), or easily replaced as needed.

The filter 120 of this disclosure is preferably formed from a material that has a filtration efficiency of 95 percent (polypropylene, etc.), although still other filter materials may be used that achieve this desired level of efficiency of filtration. Likewise, the filter 120 is designed such that the compression force of the filter is spread out over the exterior surface of the cage 108 to hold the filter in place. The cage 108 has an outer end that is closed off by the lens 110 preferably formed of an anti-fogging material (e.g., polycarbonate, etc.). This allows the facial expressions of the user to be seen by nearby listeners which further aids in the communication process.

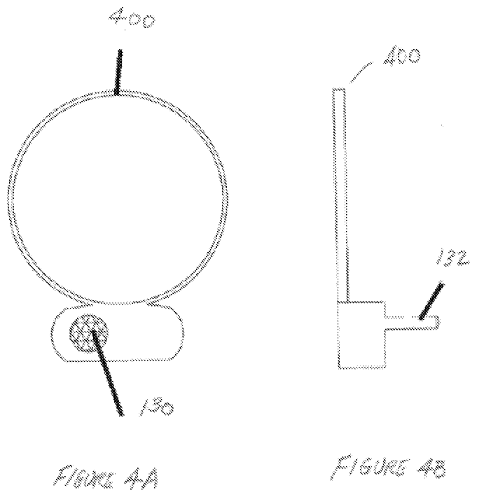

FIG. 4 (FIGS. 4A and 4B) illustrates the snap fit retainer ring 400 that may be joined to the face mask (i.e., integrated into the cage (FIGS. 1-2), or subsequently secured thereto such as with the embodiment of FIG. 3). The snap fit ring 400 preferably has a housing that contains both the amplifier 130 and the microphone 132. This embodiment is very similar to the first except it allows a user to manually add the microphone and amplifier circuit.

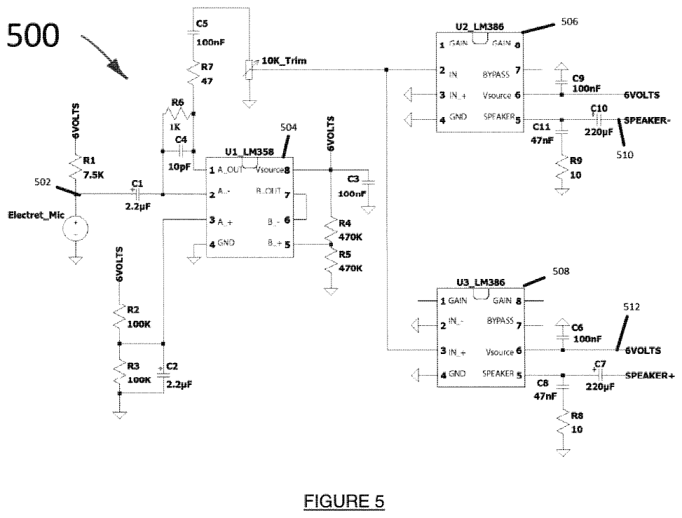

The amplifier/speaker 130 and microphone 132 are preferably both operated by the same circuit 500 (FIG. 5). The purpose of the circuit 500 is to filter a user's voice to amplify the output. This allows for a user to amplify their voice to aid in vocal comprehension while wearing the face mask 100. FIG. 5 illustrates the amplifier and microphone circuit 500. The input signal of the electric microphone 502 is sent to a dual operational amplifier 504. This output is then filtered and sent as input to a first low voltage audio amplifier 506 and a second low voltage audio amplifier 508. These amplifiers then output a positive speaker signal 510 and a negative speaker signal 512. This circuit allows the user to have their voice amplified in order to help clarify vocal communication while wearing a face mask. However, one skilled in the art will recognize that other variations of a circuit could be used to amplify the voice of the user and provide an amplified volume to the voice of the user that is otherwise muffled due to wearing the face mask.

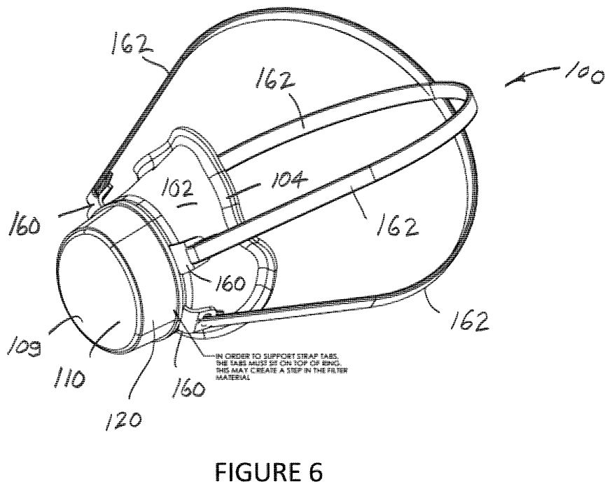

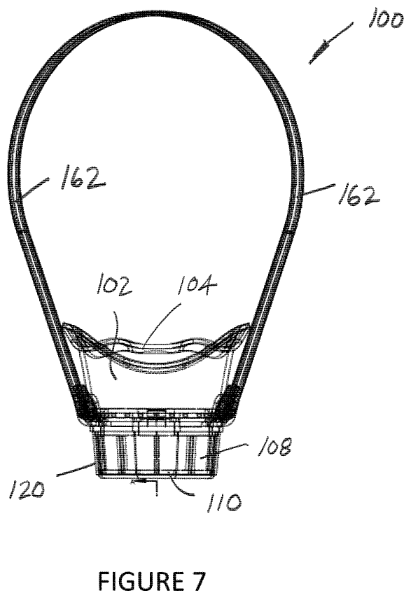

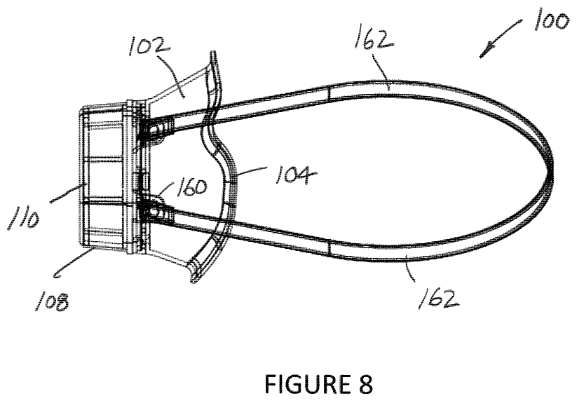

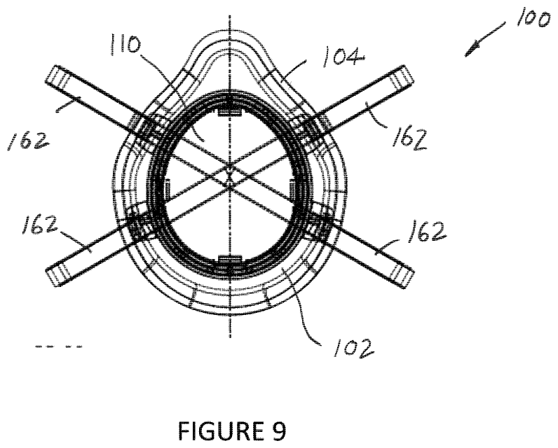

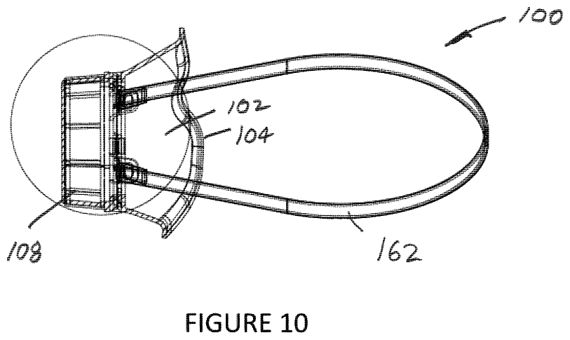

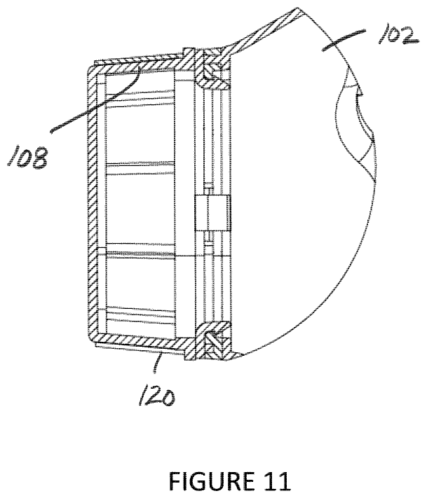

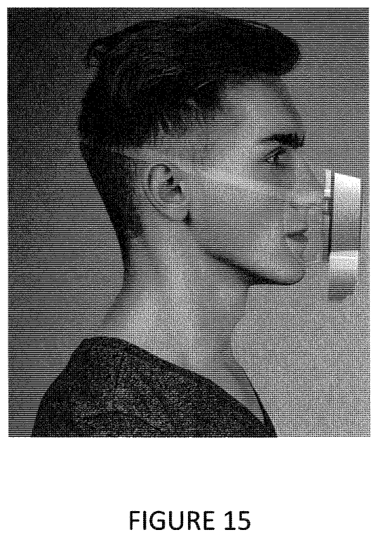

FIGS. 6-11 generally show the basic face mask assembly (with the amplifier/speaker/microphone assembly removed for ease of illustration) and the addition of circumferentially spaced tabs 160 on the cage 108 adapted to receive one end of elongated straps 162. The straps 162 may be adjustable, or sufficiently elastic to allow a comfortable fit over the head of a user (FIGS. 14-15). The straps 162 may be separate straps or connected at one end (FIG. 6) with terminal ends of the individual arms of the strap(s) secured to the individual, circumferentially spaced tabs 160.

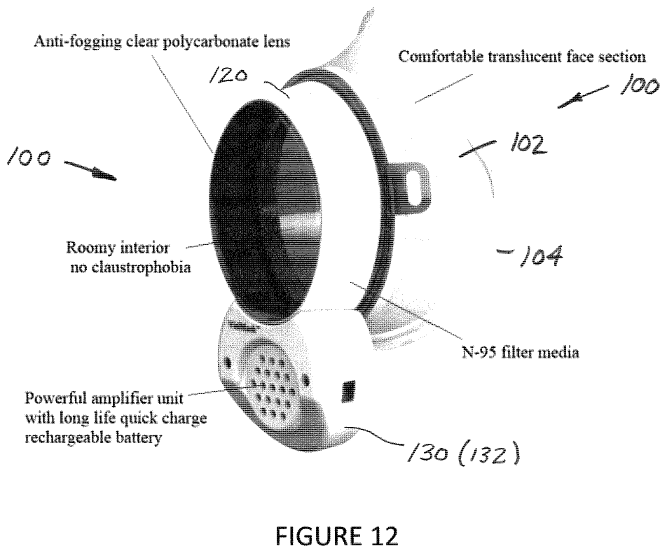

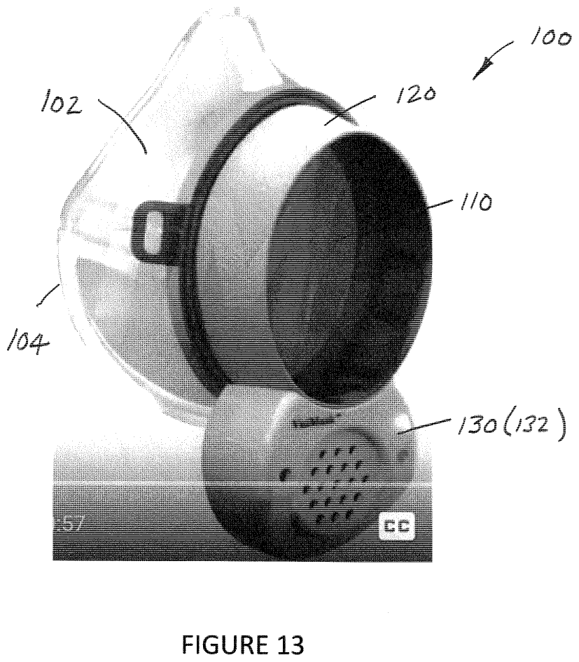

FIGS. 12-13 illustrates the inclusion of the speaker/microphone assembly. As shown, the speaker/microphone assembly 130, 132 preferably is located beneath the opening in the filter end of the face mask 100. Thus, the speaker directs the amplified voice of the face mask user toward an adjacent listener, and the listener is also able to view the mouth of the user through the clear lens 110. Since the facial portion 102 is preferably translucent, overall facial expressions are also evident to a listener.

In summary, the facemask allows the mouth to be shown and also has an audio amplifier that projects the wearer's voice clearly. Breathing is free and easy due to the large surface area of the filter 120. The face mask 100 clarifies “in person” communication since the voice is amplified and because the facial expressions are able to be seen. Replacement or repair of the rechargeable battery, replaceable lens, and filter components can also be easily achieved.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

I claim:

1. A face mask comprising:
a plastic face shield having a distal, open end configured to cover an associated user's mouth and nose and a proximal end having an opening;
a cage secured to extending outwardly from the proximal end of the face shield;
a filter received in the cage; and
an amplifier and microphone secured to an outer, terminal end of the cage.

2. The face mask of claim 1, wherein the filter is comprised of a material that has a filtration efficiency greater than 95 percent.

3. The face mask of claim 1, wherein the filter is comprised of polypropylene fiber.

4. The face mask of claim 1, wherein the outer, terminal end of the cage is made of an anti-fogging material.

5. The face mask of claim 4, wherein the outer, terminal end of the cage is made at least in part of polycarbonate.

6. The face mask of claim 1, wherein the microphone is mounted in in the face shield.

7. The face mask of claim 1, further comprising a circuit that controls operation of the amplifier and microphone.

8. The face mask of claim 1, wherein the microphone includes a dual operational amplifier that receives input from an associated user, filters the input and then outputs a signal to first and second low voltage audio power amplifiers which then output a positive speaker signal and a negative speaker signal.

9. A face mask comprising:
a concave soft plastic face shield having a distal, open end to receive a user's mouth and nose and a proximal end with a circular opening;
a cage having a back end secured on the circular opening of the soft plastic face shield and a front end spaced from the back end, wherein the cage extends outward from the proximal end of the soft plastic face shield;
a filter sleeve fixated between the front and back end of the cage;

10. The face mask of claim 9, wherein the filter sleeve is comprised of a material that has a filtration efficiency of 95 percent.

11. The face mask of claim 10, wherein the filter sleeve is comprised of polypropylene fiber.

12. The face mask of claim 9, wherein the front end of the cage is made of an anti-fogging material.

13. The face mask of claim 12, wherein the front end of the cage is made of polycarbonate.

14. The fact mask of claim 9, wherein a retainer ring is snap fit onto the back end cage.

15. The face mask of claim 14, wherein a microphone and amplifier are attached to the retainer ring.

16. The face mask of claim 15, wherein the microphone is placed in a knockout hole of the plastic face shield.
